(19) United States
(12) Patent Application Publication
(10) Pub. No.: US 2015/0199943 A1
(43) Pub. Date: Jul. 16, 2015

(54) DISPLAY DEVICE AND OPERATING METHOD THEREOF

(71) Applicant: Samsung Display Co., Ltd., Yongin-City (KR)

(72) Inventors: MyeongSu KIM, Hwaseong-si (KR); JAEHO CHOI, Seoul (KR)

(21) Appl. No.: 14/460,129

(22) Filed: Aug. 14, 2014

(30) Foreign Application Priority Data
Jan. 10, 2014 (KR) 10-2014-0003497

(51) Int. Cl. G09G 5/18

(52) U.S. Cl. CPC G09G 5/18

(57) ABSTRACT

A display device is provided which includes a display panel including a display area including a first display area and a second display area, a plurality of first and second pixels disposed in the first and second display area, respectively, a driving circuit unit configured to generate first and second image signals corresponding to the plurality of first and second pixels, a first and second control unit configured to convert first and second image signals sequentially receive the first and second image signals corresponding to the plurality of first and second pixels in the order of distance from a boundary between the first display area and the second display area.

### CROSS-REFERENCE TO RELATED APPLICATIONS

A claim for priority under 35 U.S.C. §119 is made to Korean Patent Application No. 10-2014-0003497 filed Jan. 10, 2014, in the Korean Intellectual Property Office, the entire contents of which are hereby incorporated by reference.

### BACKGROUND

The inventive concepts described herein relate to a display device, and more particularly, relate to a display device including a plurality of controllers and a driving method thereof.

A typical display device comprises a display panel for displaying images and gate and data drivers for driving the display panel. The display panel comprises a plurality of gate lines, a plurality of data lines, and a plurality of pixels connected to the gate lines and the data lines. The gate lines receive gate signals from the gate driver, and the data lines receive data voltages from the data driver. The pixels are supplied with the data voltages through the data lines in response to the gate signals transferred via the gate lines. The pixels express gray scales corresponding to the data voltages. Thus, an image is displayed.

Also, the display device comprises a controller to control the gate and data drivers. The controller controls the gate and data drivers such that the gate signals and the data voltages are provided to corresponding pixels.

### SUMMARY

One aspect of embodiments of the inventive concept is directed to provide a display device which comprises a display panel including a display area and a non-display area surrounding the display area, the display area including a first display area and a second display area, a plurality of first pixels disposed in the first display area and connected to a plurality of gate lines and a plurality of first data lines, a plurality of second pixels disposed in the second display area and connected to the plurality of gate lines and a plurality of second data lines, a driving circuit unit configured to generate first and second image signals corresponding to the plurality of first and second pixels, a first control unit configured to convert first image signals into first data voltages and to provide the first data voltages to the plurality of first pixels, and a second control unit configured to convert second image signals into second data voltages and to provide the second data voltages to the plurality of second pixels. The driving circuit unit is configured to sequentially provide the first and second image signals corresponding to the plurality of first and second pixels to the respective first control unit and second control unit in the order of distance from a boundary between the first display area and the second display area.

In exemplary embodiments, the driving circuit unit is configured to generate a first control signal to be provided to the first control unit and a second control signal to be provided to the second control unit, the first control unit converts the first image signals into the first data voltages in response to the first control signal, and the second control unit converts the second image signals into the second data voltages in response to the second control signal.

In exemplary embodiments, the first control unit comprises a first timing controller configured to generate a first data control signal and a gate control signal in response to the first control signal and to convert a data format of the first image signals; and a first data driving unit configured to convert the first image signals with the converted data format into the first data voltages in response to the first data control signal and to provide the first data voltages to the plurality of first pixels.

In exemplary embodiments, the second control unit comprises a second timing controller configured to generate a second data control signal in response to the second control signal and to convert a data format of the second image signals; and a second data driving unit configured to convert the second image signals with the converted data format into the second data voltages in response to the second data control signal and to provide the second data voltages to the plurality of second pixels.

In exemplary embodiments, the first and second control units are disposed on the non-display area of the display panel adjacent to the first and second display areas.

In exemplary embodiments, the first and second control units are disposed on the non-display area in a COG manner.

In exemplary embodiments, the display device further comprises a gate driving unit disposed in the non-display area and configured to generate a plurality of gate signals to be provided to the plurality of gate lines.

In exemplary embodiments, the first control unit generates the gate signals to be provided to the gate driving unit, and the gate driving unit sequentially provides the plurality of gate signals to the gate lines by a row at a time.

In exemplary embodiments, the first and second control units exchange the first and second image signals.

In exemplary embodiments, each of the plurality of first and second pixels is provided with a data voltage generated with reference to image signals of other pixels..

In exemplary embodiments, the first and second image signals corresponding to pixels disposed to be a substantially same distance from the boundary are simultaneously provided to the first and second control units.

In exemplary embodiments, the driving circuit unit provides the first and second image signals to every gate line.

Another aspect of embodiments of the inventive concept is directed to provide a method of driving a display device, the method comprising providing a plurality of first image signals corresponding to a plurality of first pixels disposed in a first display area of a display panel to a first control unit, providing a plurality of second image signals corresponding to a plurality of second pixels disposed in a second display area of the display panel to a second control unit, and converting the plurality of first and second image signals into first and second data voltages corresponding to the plurality of first and second pixels, wherein the plurality of first pixels are connected to a plurality of gate lines and a plurality of first data lines, and the plurality of second pixels are connected to the plurality of gate lines and a plurality of second data lines, and wherein the plurality of first and second image signals are configured to be provided to the first control unit and the second control unit in the order of distance from a boundary between the first display area and the second display area.

In exemplary embodiments, each of the plurality of first and second pixels is provided with a data voltage generated with reference to image signals of other pixels.

In exemplary embodiments, the plurality of first and second image signals corresponding to pixels disposed to be a substantially same distance from the boundary are simultaneously provided to the first and second control units.

In exemplary embodiments, the first and second image signals are provided by a row unit of gate lines.

15

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 shows a display device according to an embodiment of the inventive concept;

FIGS. 2 and 3 are block diagrams schematically illustrating first and second control units shown in FIG. 1, according to an embodiment of the inventive concept;

FIG. 4 is a timing diagram schematically illustrating image signals provided from a driving circuit unit to first and second control units;

FIG. 5 is a timing diagram schematically illustrating a method where first and second image signals are provided from a driving circuit unit to first and second control units, according to an embodiment of the inventive concept; and

FIG. 6 is a flow chart schematically illustrating a method of providing image signals to first and second control units, according to an embodiment of the inventive concept.

10

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

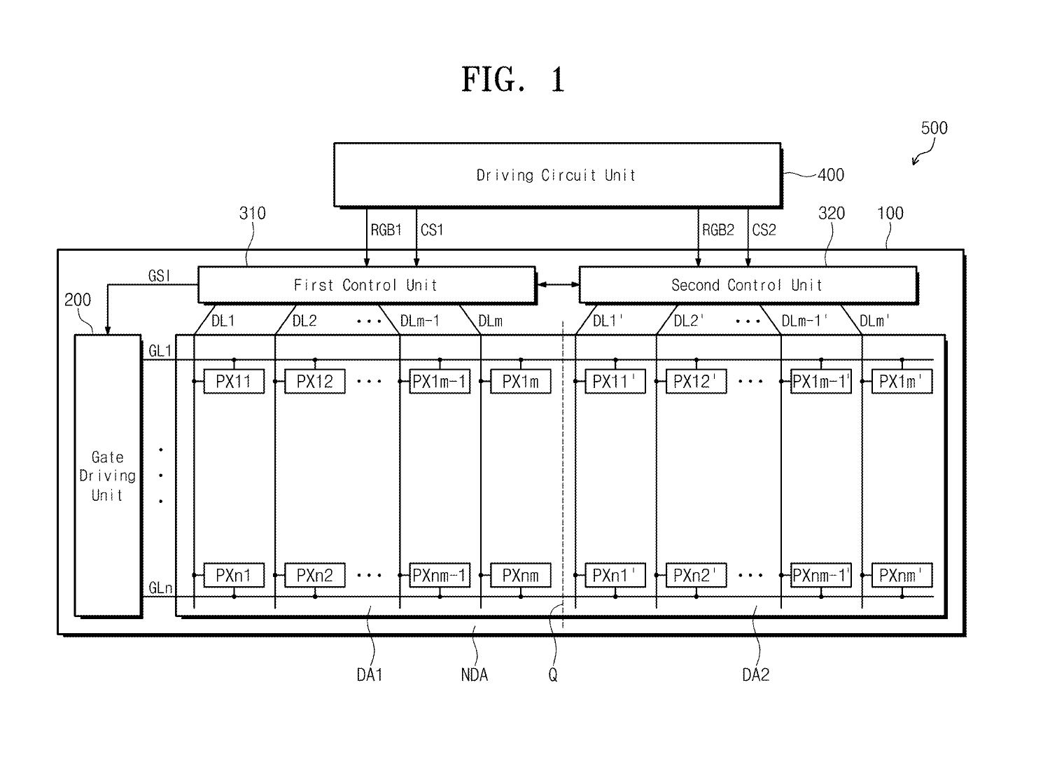

FIG. 1 shows a display device according to an embodiment of the inventive concept.

Referring to FIG. 1, a display device 500 includes a display panel 100, a gate driving unit 200, a first control unit 310, a second control unit 320, and a driving circuit unit 400.

In exemplary embodiments, the display panel 100 includes a display area DA and a non-display area NDA. The display area includes a first display area DA1 and a second display area DA2. That is, the display device 500 according to the inventive concept displays images through the first and second display areas DA1 and DA2 which are controlled by two different control units, that is the first control unit 310 and the second control unit 320. The non-display area NDA surrounds the display area DA

In detail, the display panel 100 includes a plurality of first pixels PX11 to PXnm is arranged in a matrix shape in the first display area DA1 a plurality of second pixels PX11′ to PXnm′ is arranged in a matrix shape in the second display area DA2, a plurality of gate lines GL1 to GLn, and a plurality of first and second data lines DL1 to DL1 m and DL1′ to DLm′ crossing the gate lines GL1 to GLn. The first and second data lines DL1 to DL1m and DL1′ to DLm′ are insulated from the gate lines GL1 to GLn.

The gate lines GL1 to GLn are connected to the gate driving unit 200 and sequentially receive gate signals. The first data lines DL1 to DLm are connected to the first control unit 310 and receive first data voltages. The first data voltages are analog voltages. The second data lines DL1′ to DLm′ are connected to the second control unit 320 and receive second data voltages. The second data voltages are analog voltages.

First and second pixels PX11 to PXnm and PX11′ to PXnm′ are arranged to form an n m matrix. Here, “n” and “m” are an integer more than 0.

The first pixels PX11 to PXnm are connected to corresponding gate lines GL1 to GLn and corresponding first data lines DL1 to DLm. The second pixels PX11′ to PXnm′ are connected to corresponding gate lines GL1 to GLn and corresponding second data lines DL1′ to DLm′. The first pixels PX11 to PXnm are supplied with first data voltages via the first data lines DL1 to DLm in response to the gate signals provided via the corresponding gate lines GL1 to GLn. The second pixels PX′11 to PX′nm are supplied with second data voltages via the second data lines DL1′ to DLm′ in response to the gate signals provided via the corresponding gate lines GL1 to GLn. The first and second pixels PX11 to PXnm and PX11′ to PXnm′ express gray scales corresponding to the first and second data voltages.

The gate driving unit 200 is placed at a non-display area NDA adjacent to one side of the display area DA. In exemplary embodiments, the gate driving unit 200 is an ASG (Amorphous Silicon TFT Gate driver circuit) and is formed on a non-display area NDA adjacent to a left side of the display area DA.

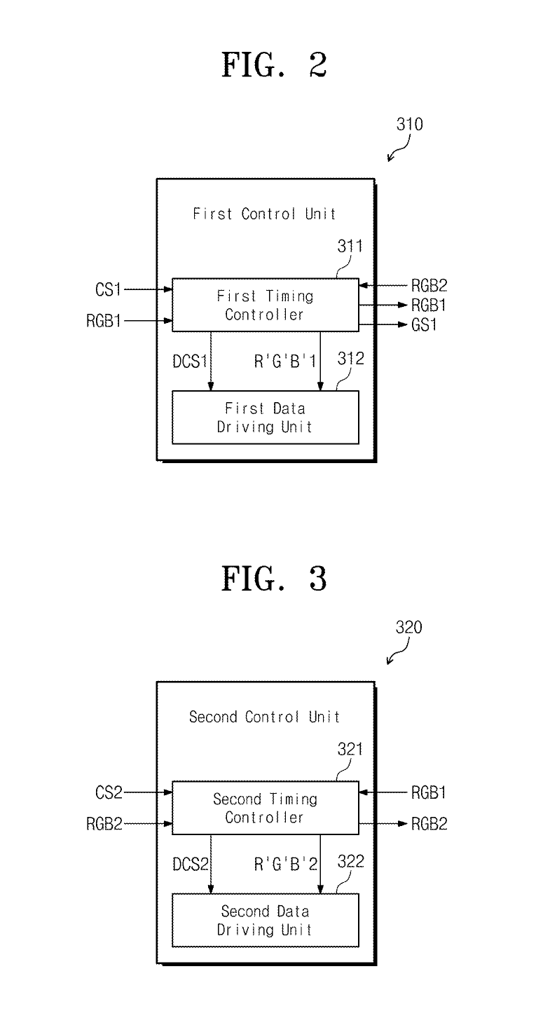

The gate driving unit 200 generates gate signals in response to a gate control signal GSI that is provided from a timing controller (refer to FIG. 2) included in the first control unit 310. The gate signals are sequentially provided to the first and second pixels PX11 to PXnm and PX11′ to PXnm′ via the gate lines GL1 to GLn by one row at a time; hence, the first and second pixels PX11 to PXnm and PX11′ to PXnm′ are driven by one row at a time.

The first control unit 310 receives a plurality of first image signals RGB1 and a first control signal CS1 from the driving circuit unit 400. The first control unit 310 converts the first image signals RGB1 into the first data voltages in response to the first control signal CS1. The first control unit 310 provides the first data voltages to the first pixels PX11 to PXnm via the first data lines DL1 to DLm.

Also, the first control unit 310 generates the gate control signal GSI to be provided to the gate driving unit 200 in response to the first control signal CS1.

The second control unit 320 receives a plurality of second image signals RGB2 and a second control signal CS2 from the driving circuit unit 400. The second control unit 320 converts the second image signals RGB2 into the second data voltages in response to the second control signal CS2. The second control unit 320 provides the second data voltages to the second pixels PX11′ to PXnm′ via the second data lines DL1′ to DLm′.

In exemplary embodiments, the first and second control units 310 and 320 are mounted on the non-display area NDA of the display panel 100 adjacent to a side of the display area DA in a Chip On Glass manner.

The driving circuit unit 400 generates the first and second image signals RGB1 and RGB2 to be displayed and the first and second control signals CS1 and CS2. The driving circuit unit 400 provides the first image signals RGB1 and the first control signal CS1 to the first control unit 310 and the second image signals RGB2 and the second control signal CS2 to the second control unit 320.

In exemplary embodiments, the driving circuit unit 400 sequentially provides the first image signals RGB1 to the first control unit 310. For example, after providing the first control unit 310 with a first image signal RGB1 corresponding to a pixel PX11 in a first row of the first display area DA1, the driving circuit unit 400 provides the first control unit 310 with a first image signal RGB1 corresponding to a pixel PX12 in the first row of the first display area DA1.

In exemplary embodiments, the driving circuit unit 400 sequentially provides the second image signals RGB2 to the second control unit 320. For example, after providing the second control unit 320 with a second image signal RGB2 corresponding to a pixel PX11′ in the first row of the second display area, the driving circuit unit 400 provides the second control unit 320 with a second image signal RGB2 corresponding to a pixel PX12′ in the first row of the second display area.

Also, the driving circuit unit 400 simultaneously provides the first and second image signals RGB1 and RGB2 with the first and second control units 310 and 320. For example, the first image signal RGB1 corresponding to the pixel PX11 and the second image signal RGB2 corresponding to the pixel PX11′ may be simultaneously provided to the first and second control units 310 and 320.

The first and second control units 310 and 320 convert the first and second image signals RGB1 and RGB2 into the first and second data voltages and provides the first and second data voltages to the first and second pixels PX11 to PXnm and PX11′ to PXnm′.

In exemplary embodiments, the first and second data voltages provided to the first and second pixels PX11 to PXnm and PX11′ to PXnm′ may be generated with reference to adjacent image signals corresponding to adjacent pixels adjacent to the first and second pixels PX11 to PXnm and PX11′ to PXnm′ respectively. That is, when converting first and second image signals RGB1 and RGB2 corresponding to the first and second pixels PX11 to PXnm and PX11′ to PXnm′ into the first and second data voltages, the first and second control units 310 and 320 refer both an image signal corresponding to each pixel and image signals corresponding to pixels adjacent to each pixel. For this image processing, the first and second control units 310 and 320 may utilize image processing technology such as Pentile Rendering, CABC Rendering, Color enhance, and the like.

In particular, the first and second control units 310 and 320 may exchange first and second image signals RGB1 and RGB2 provided from the driving circuit unit 400 to convert first and second image signals RGB1 and RGB2 corresponding to pixels disposed around a boundary Q into the first and second data voltages. Here, the boundary Q is a boundary between the first display area DA1 and the second display area DA2.

For example, a first data voltage of a 1 x m pixel PX1 m in the first row of the first display area DA1 which is connected to a m-th data line DLm and a first gate line GL1 is decided with reference to a first image signal RGB1 corresponding to a 1×(m−1) pixel PX1 m-1 in the first row of the first display area DA1 which is connected to a (m−1)th data line DLm-1 and the first gate line GL1 and a second image signal RGB2 corresponding to a 1×1′ pixel PX11′ in the first row of the second display area DA2 which is connected to a (m+1)th data line DL1′ and the first gate line GL1.

That is, the first control unit 310 refers first and second image signals RGB1 and RGB2 corresponding to the 1×(m−1) pixel PX1m-1 in the first row of the first display area DA1 and the 1×1′ pixel PX11′ in the first row of the second display area DA2 to generate a first data voltage of the 1×m pixel PX1m in the first row of the first display area DA1. In this case, the first control unit 310 need to receive a second image signal RGB2 corresponding to the 1×1′ pixel PX11′ in the first row of the second display area DA2 from the second control unit 320.

As another example, a second data voltage of the 1×1′ pixel PX11′ in the first row of the second display area DA2 which is connected to the (m+1)th data line DL1′ and the first gate line GL1 is decided with reference to a first image signal RGB1 corresponding to the 1×m pixel PX1 m in the first row of the first display area DA1 which is connected to the m-th data line DLm and the first gate line GL1 and a second image signal RGB2 corresponding to a 1×2′ pixel PX12′ in the first row of the second display area DA2 which is connected to a (m+2)th data line DL2′ and the first gate line GL1.

That is, the second control unit 320 refers first and second image signals RGB1 and RGB2 corresponding to the 1×m pixel PX1m in the first row of the first display area DA1 and the 1×2 pixel PX12′ in the first row of the second display area DA2 to generate a data voltage of the 1×1′ pixel PX11′ in the first row of the second display area DA2. In this case, the second control unit 320 need to receive a first image signal RGB1 corresponding to the 1×m pixel PX1 m in the first row of the first display area DA1 from the first control unit 310.

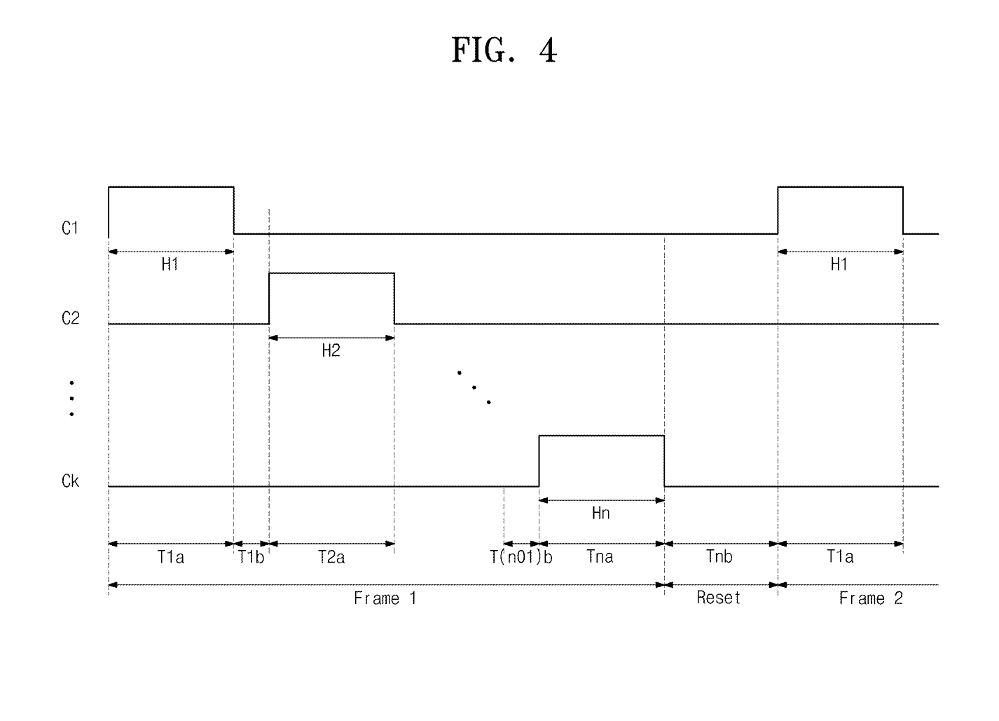

As described above, the first and second control units 310 and 320 exchange first and second image signals RGB1 and RGB2 to generate the first and second data voltages of the 1×1 and 1×1′ pixels PX11 and PX11′ arranged adjacent to the boundary Q. If there is no enough time to exchange the first and second image signals RGB1 and RGB2, a problem such as noise, signal distortion, etc. may occurs. For example, the driving circuit unit 400 provides the first control unit 310 with a first image signal RGB1 corresponding to the 1×m pixel PX1m among the first image signals RGB1. In this case, there is no enough time to decide the second data voltage for a 1×1′ pixel PX11′ after the second control unit 320 receives a first image signal RGB1 corresponding to the 1×m pixel PX1m. This will be more fully described with reference to FIG. 4.

To solve the above-described problem, the display device 500 according to the inventive concept provides a manner which can secure enough time for the first and second control units 310 and 320 to exchange first and second image signals RGB1 and RGB2.

There is described an example in which image signals corresponding to two pixels are referred to generate a data voltage corresponding to each pixel. However, the inventive concept is not limited thereto. That is, the first and second control units 310 and 320 exchange the first and second image signals RGB1 and RGB2 corresponding to the first and second pixels PX11 to PXnm and PX11′ to PXnm′ according to an image processing manner.

FIGS. 2 and 3 are block diagrams schematically illustrating first and second control units shown in FIG. 1, according to an embodiment of the inventive concept.

In exemplary embodiments, the first and second control units 310 and 320 may be a TED (Timing controller embedded data driver). That is, each of the first and second control units 310 and 320 includes a data driving unit and a timing controller that are integrated in a single IC chip formed on a single substrate such as silicon wafer. Referring to FIG. 2, the first control unit 310 includes a first timing controller 311 and a first data driving unit 312.

The first timing controller 311 receives the first control signal CS1 and the first image signals RGB1 from the driving circuit unit 400 (refer to FIG. 1). The first timing controller 311 converts a data format of the first image signals RGB1 to be suitable for the interface specification of the first data driving unit 312. The first timing controller 311 provides the first data driving unit 312 with a first image signal R′G′B′1 thus converted.

In exemplary embodiments, the first timing controller 311 provides the first image signal RGB1 to a second timing controller 321. For example, the second timing controller 321 receives the first image signal RGB1 through the first timing controller 311 to generate data voltages for boundary pixels adjacent to the boundary Q among the second pixels PX11′ to PXnm′.

The first timing controller 311 also generates a gate control signal GSI (refer to FIG. 1) to be provided to a gate driving unit 200 in response to the first control signal CS1.

The first timing controller 311 generates a first data control signal DCS1 for controlling a first data driving unit 312 in response to the first control signal CS1.

The first data driving unit 312 converts the first image signals R′G′B′1 with the converted data format into first data voltages in response to the first data control signal DCS1. The first data driving unit 312 provides the first data voltages to the first pixels PX11 to PXnm disposed in a first display area DA1. Thus, an image is displayed.

Referring to FIG. 3, the second control unit 320 includes a second timing controller 321 and a second data driving unit 322.

The second timing controller 321 receives a second control signal CS2 and a second image signals RGB2 from the driving circuit unit 400. The second timing controller 321 converts a data format of the second image signals RGB2 to be suitable for the interface specification of the second data driving unit 322. The second timing controller 321 provides the second data driving unit 322 with a second image signal R′G′B′2 thus converted.

In exemplary embodiments, the second timing controller 321 provides the second image signal RGB2 to a first timing controller 311. For example, the first timing controller 311 receives the second image signal RGB2 through the second timing controller 321 to generate data voltages for boundary pixels adjacent to the boundary Q among the first pixels PX11 to PXnm.

The second timing controller 321 generates a second data control signal CS2 for controlling a second data driving unit 322 in response to the second control signal CS2.

The second data driving unit 322 converts the image signals R′G′B′2 with the converted data format into second data voltages in response to the second data control signal DCS2. The second data driving unit 322 provides the second data voltages to the second pixels PX11′ to PXnm′ disposed in a second display area DA2. Thus, an image is displayed.

FIG. 4 is a timing diagram schematically illustrating image signals provided from a driving circuit unit to first and second control units.

Referring to FIGS. 1 and 4, the first and second image signals RGB1 and RGB2 corresponding to first and second data voltages to be provided to the first second pixels PX11 to PXnm and the second pixel PX11′ to PXnm′ are sequentially provided to the first and second control units 310 and 320 by a row at a time. A driving circuit unit 400 respectively provides the first and second control units 310 and 320 with the first and second image signals RGB1 and RGB2 corresponding to the first and second pixels PX11 to PXnm and PX11′ to PXnm′ by a row at a time in synchronization with first to k-th clock signals C1 to Ck.

A first frame period Framel includes a first to n-th times T1a to Tna and a first to (n-1)th blank times T1b to T(n-1)b. In detail, during the first time T1a, the driving circuit unit 400 provides the first and second control units 310 and 320 with the first and second image signals RGB1 and RGB2 corresponding to the first and second pixels PX11 to PX1m and PX11′ to PX1m′ arranged in a first row in response to a high-level period H1 of the first clock signal C1. That is, during the first time T1a, the first and second image signals RGB1 and RGB2 corresponding to pixels connected to a first gate line GL1 are provided to the first and second control units 310 and 320, respectively.

The first blank time T1b is a time between a falling time of the first clock signal C1 and a rising time of a second clock signal C2. During the first blank time T1b, no clock signal has high level.

During a second time T2a when the second clock signal C2 rises to a high-level period H2, the driving circuit unit 400 provides the first and second control units 310 and 320 with the first and second image signals RGB1 and RGB2 corresponding to first and second pixels PX21 to PX2m and PX21′ to PX2m′ arranged in a second row.

As described above, operations executed during the first and second times T1a and T2a are iterated until a period where the k-th clock signal Ck has a high level. That is, the driving circuit unit 400 sequentially provides the first and second control units 310 and 320 with first and second image signals RGB1 and RGB2 corresponding to pixels connected to first to n-th gate lines GL1 to GLn.

During the first frame Frame1, the first and second image signals RGB1 and RGB2 corresponding to the first and second pixels PX11 to PXnm and PX11′ to PXnm′ connected to each gate line are provided to the first and second control units 310 and 320.

During a n-th blank time Tnb, the first and second control units 310 and 320 reset information of image signals provided during the first frame Frame1. That is, the n-th blank time Tnb corresponds to a reset period between the first frame Framel and a second frame Frame2 following the first frame Frame1. Here, the first blank time T1b is shorter than the n-th blank time Tnb.

A second frame period Frame2 iterates operations executed during the first frame Frame1.

As described above, the driving circuit unit 400 provides first and second image signals RGB1 and RGB2 corresponding to pixels connected to the same gate line at a time.

A conventional driving circuit unit provides a first control unit with a first image signal RGB1 corresponding to a 1×m pixel PX1m in the first row of the first display area DA1 connected to a first gate line GL1 during a high-level period H1 of the first clock signal C1. Also, the driving circuit unit provides a second control unit with a second image signal RGB2 corresponding to a 1×1′ first pixel PX11′ in the first row of the second display area DA2 during a high-level period H1 of the first clock signal C1.

In this case, the second control unit 320 refers to first and second image signals RGB1 and RGB2 corresponding to a 1×m pixel PX1 m in the first row of the first display area DA1 and a 1×2 pixel PX12′in the first row of the second display area DA2 to generate a second data voltage of a 1×1′ pixel PX11′ in the first row of the second display area DA2. However, because the first blank time T1b is very short, the second control unit 320 may not receive the first image signal RGB1 corresponding to the 1×m pixel PX1m in the first row of the first display area DA1 from the first control unit 310.

In detail, conventionally, the first control unit sequentially receives first image signals RGB1 corresponding to all first pixels (adjacent to a boundary Q) during a high-level period H1 of the first clock signal C1. In this case, a first image signal RGB1 corresponding to the 1×m pixel PX1m in the first row of the first display area DA1 is provided to the first control unit 310 just before the 1×1′ pixel PX11′ in the first row of the second display area receives a second image signal RGB2. To generate a second data voltage corresponding to a second pixel connected to a first gate line, the second control unit has to receive a first image signal corresponding to a first pixel connected to the last gate line from the first control unit 310 within the first blank time T1b. If the first blank time T1b is short, a time when the first and second control units 310 and 320 exchange first and second image signals RGB1 and RGB2 may be insufficient.

Thus, it is necessary to secure a sufficient time when a first image signal RGB1 is provided from the first control unit 310 to the second control unit 320. The second control unit 320 receives the first image signal RGB1 corresponding to a 1×m pixel PX1m in the first row of the first display area DA1 during the first blank time T1b.

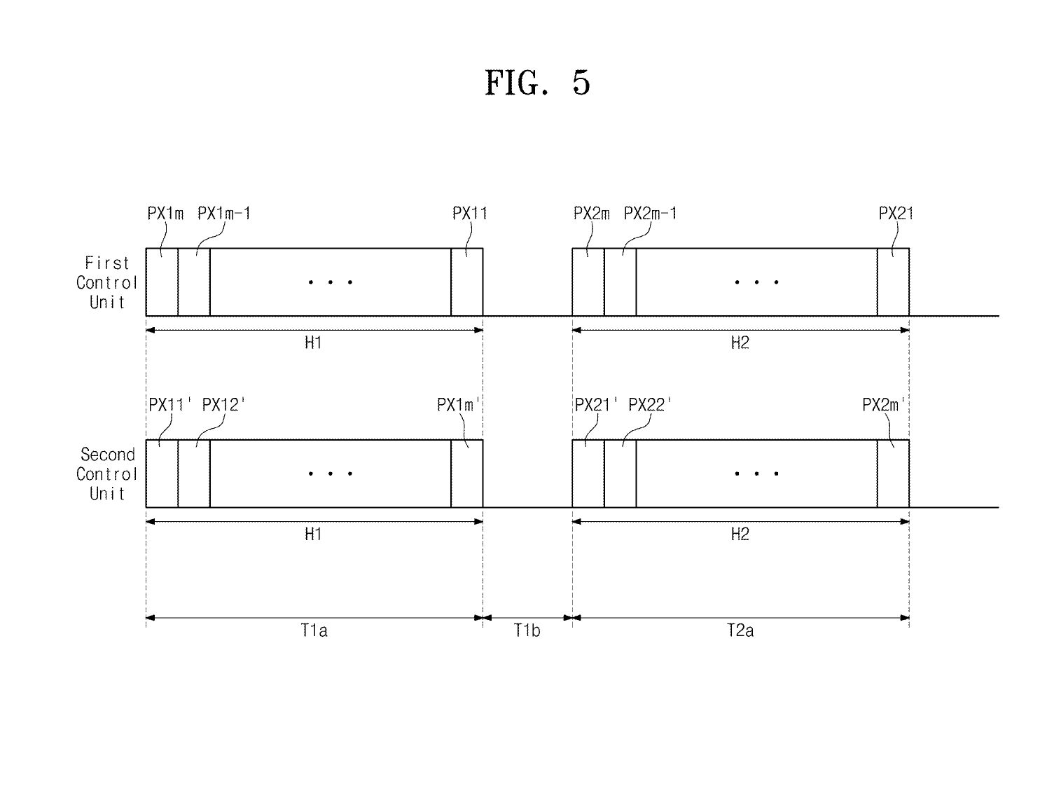

FIG. 5 is a timing diagram schematically illustrating a method where first and second image signals are provided from a driving circuit unit to first and second control units, according to an embodiment of the inventive concept.

Referring to FIGS. 1, 4 and 5, during a first period H1, a first image signal RGB1 corresponding to first pixels PX11˜PX1m connected to a first gate line GL1 is provided to a first control unit 310. Here, the first pixels PX11˜PX1m connected to the first gate line GL1 are first pixels PX11 to PX1m included in a first display area DA1.

At the same time, during the first period H1, a second image signal RGB2 corresponding to second pixels PX11′˜PX1m′ connected to the first gate line GL1 is provided to a second control unit 320. Here, the second pixels PX11′˜PX1m′ connected to the first gate line GL1 are second pixels PX11′˜PX1m′ included in a second display area DA2.

In particular, the driving circuit unit 400 according to an embodiment of the inventive concept sequentially provides image signals to the first and second control units 310 and 320 from first and second pixels disposed to be adjacent to a boundary Q. That is, first and second image signals RGB1 and RGB2 corresponding to first and second pixels disposed close to the boundary Q is first provided, and the first and second image signals RGB1 and RGB2 corresponding to first and second pixels disposed in the furthermost from the boundary Q is provided at the end.

In detail, during a first time T1b, the driving circuit unit 400 first provides the first control unit 310 with a first image signal RGB1 corresponding to a 1×m pixel PX1m in the first row of the first display area DA1 disposed to be immediately adjacent to the boundary Q. At the same time, the driving circuit unit 400 first provides the second control unit 320 with a second image signal RGB2 corresponding to a 1×1′ pixel PX11′ in the first row of the second display area DA2 disposed to be immediately adjacent to the boundary Q.

That is, the driving circuit unit 400 simultaneously provides the first control unit 310 with a first image signal RGB1 corresponding to a 1×m pixel PX1m in the first row of the first display area DA1 and the second control unit 320 with a second image signal RGB2 corresponding to a 1×1′ pixel PX11′ in the first row of the second display area DA2.

Afterwards, the driving circuit unit 400 secondly provides the first control unit 310 with a first image signal RGB1 corresponding to a 1(m−1) pixel PX1m-1 in the first row of the first display area DA1 disposed to be secondly adjacent to the boundary Q. Likewise, at the same time, the driving circuit unit 400 first provides the second control unit 320 with a second image signal RGB2 corresponding to a 1×2′ pixel PX12′ in the first row of the second display area PX12′ disposed to be secondly adjacent to the boundary Q.

Afterwards, first and second image signals RGB1 and RGB2 corresponding to first and second pixels PX11 to PXnm and PX11′ to PXnm′ are sequentially provided to the remaining first and second pixels from the pixels close to the boundary Q to the pixels furthermost from the boundary Q.

As described above, the driving circuit unit 400 sequentially provides the first control unit 310 with a first image signal RGB1 corresponding to the first pixels in the order of distance from the boundary Q between the first display area and the second display area. Likewise, at the same time, the driving circuit unit 400 sequentially provides the second control unit 320 with a second image signal RGB2 corresponding to the second pixels PX11′ to PXnm′ in the order of distance from the boundary Q between the first display area DA1 and the second display area DA2 .

In detail, the first control unit 310 is first provided with a second image signal RGB2 corresponding to a 1×1′ pixel PX11′ in the first row of the second display area DA2 adjacent to the boundary Q during a first period H1. The second control unit 320 is first provided with a first image signal RGB1 corresponding to a 1×m pixel PX1 m in the first row of the first display area DA1 adjacent to the boundary Q during the first period H1.

Thus, the first and second control units 310 and 320 sufficiently exchange first and second image signals RGB1 and RGB2 during the first period H1.

As described above, the first and second control units 310 and 320 sufficiently exchange necessary image signals before a second time T2a. Thus, if the second control unit 320 generates a data voltage corresponding to a 1×1′ pixel PX11′ in the first row of the second display area DA2, the first control unit 310 provides the second control unit 320 with a first image signal RGB1 corresponding to a 1×m pixel PX1m in the first row of the first display area DA1 during the first time T1a. The second control unit 320 generates a data voltage to be provided to the 1×1′ pixel PX11′ in the first row of the second display area DA2 using a first image signal RGB1.

During remaining periods H2 to Hn, the driving circuit unit 400 provides the first and second control units 310 and 320 with first and second image signals RGB1 and RGB2 in the same manner as the first period H1.

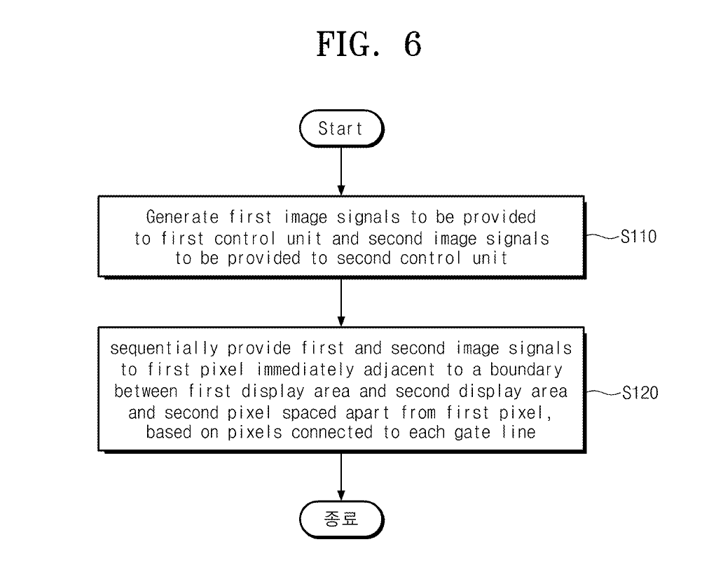

FIG. 6 is a flow chart schematically illustrating a method of providing image signals to first and second control units, according to an embodiment of the inventive concept.

Referring to FIGS. 1 and 6, in step S110, a driving circuit unit 400 generates first image signals RGB1 to be provided to a first control unit 310 and second image signals RGB2 to be provided to a second control unit 320. Also, the driving circuit unit 400 generates a first control signal CS1 to be provided to the first control unit 310 and a second control signal CS2 to be provided to the second control unit 320.

In step S120, first and second image signals RGB1 and RGB2 are sequentially provided to a first pixel immediately adjacent to a boundary Q between a first display area DA1 and a second display area DA2 and a second pixel spaced apart from the first pixel, among a plurality of pixels connected to each gate line.

The first control unit 310 receives first image signals RGB1 corresponding to pixels included in the first display area DA1 from a driving circuit unit 400 according to an operation corresponding to step S120. Likewise, the second control unit 320 receives second image signals RGB2 corresponding to pixels included in the second display area DA2 from the driving circuit unit 400.

With the above description, it is possible to prevent such a problem that the first and second control units 310 and 320 cannot exchange image signals corresponding to pixels included in different display areas. That is, a display device according to the inventive concept provides a data voltage that refers to an image signal of another pixel to every pixel. Thus, reliability of the display device is improved.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A display device comprising:
a display panel including a display area and a non-display area surrounding the display area, the display area including a first display area and a second display area;
a plurality of first pixels disposed in the first display area and connected to a plurality of gate lines and a plurality of first data lines;
a plurality of second pixels disposed in the second display area and connected to the plurality of gate lines and a plurality of second data lines;
a driving circuit unit configured to generate first and second image signals corresponding to the plurality of first and second pixels;
a first control unit configured to convert first image signals into first data voltages and to provide the first data voltages to the plurality of first pixels; and
a second control unit configured to convert second image signals into second data voltages and to provide the second data voltages to the plurality of second pixels,
wherein the driving circuit unit is configured to sequentially provide the first and second image signals corresponding to the plurality of first and second pixels to the respective first control unit and second control unit in the order of distance from a boundary between the first display area and the second display area.

2. The display device of claim 1, wherein the driving circuit unit is configured to generate a first control signal to be provided to the first control unit and a second control signal to be provided to the second control unit,
wherein the first control unit converts the first image signals into the first data voltages in response to the first control signal, and
wherein the second control unit converts the second image signals into the second data voltages in response to the second control signal.

3. The display device of claim 2, wherein the first control unit comprises:
a first timing controller configured to generate a first data control signal and a gate control signal in response to the first control signal and to convert a data format of the first image signals; and
a first data driving unit configured to convert the first image signals with the converted data format into the first data voltages in response to the first data control signal and to provide the first data voltages to the plurality of first pixels.

4. The display device of claim 3, wherein the second control unit comprises:
a second timing controller configured to generate a second data control signal in response to the second control signal and to convert a data format of the second image signals; and
a second data driving unit configured to convert the second image signals with the converted data format into the second data voltages in response to the second data control signal and to provide the second data voltages to the plurality of second pixels.

5. The display device of claim 1, wherein the first and second control units are disposed on the non-display area of the display panel adjacent to the first and second display areas.

6. The display device of claim 5, wherein the first and second control units are disposed on the non-display area in a COG manner.

7. The display device of claim 5, further comprising:
a gate driving unit disposed in the non-display area and configured to generate a plurality of gate signals to be provided to the plurality of gate lines.

8. The display device of claim 7, wherein the first control unit generates a gate control signal to be provided to the gate driving unit, and
wherein the gate driving unit generates the gate signal in response to the gate control signal and sequentially provides the gate signals to the plurality of gate lines by a row at a time.

9. The display device of claim 1, wherein the first and second control units exchange the first and second image signals.

10. The display device of claim 1, wherein each of the plurality of first and second pixels is provided with a data voltage generated with reference to image signals of other pixels.

11. The display device of claim 10, wherein the first and second image signals corresponding to the first and second pixels disposed to be a substantially same distance from the boundary are simultaneously provided to the first and second control units.

12. The display device of claim 1, wherein the first and second image signals corresponding to the first and second pixels disposed to be a substantially same distance from the boundary are simultaneously provided to the first and second control units.

13. The display device of claim 1, wherein the driving circuit unit provides the first and second image signals to every gate line.

14. A method of driving a display device, comprising:
providing a plurality of first image signals corresponding to a plurality of first pixels disposed in a first display area of a display panel to a first control unit;
providing a plurality of second image signals corresponding to a plurality of second pixels disposed in a second display area of the display panel to a second control unit; and
converting the plurality of first and second image signals into first and second data voltages corresponding to the plurality of first and second pixels,
wherein the plurality of first pixels are connected to a plurality of gate lines and a plurality of first data lines, and the plurality of second pixels are connected to the plurality of gate lines and a plurality of second data lines, and
wherein the plurality of first and second image signals are configured to be provided to the first control unit and the second control unit in the order of distance from a boundary between the first display area and the second display area.

15. The method of claim 14, wherein each of the plurality of first and second pixels is provided with a data voltage generated with reference to image signals of other pixels.

16. The method of claim 15, wherein the plurality of first and second image signals corresponding to the first and second pixels disposed to be a substantially same distance from the boundary are simultaneously provided to the first and second control units.

17. The method of claim 14, wherein the plurality of first and second image signals corresponding to the first and second pixels disposed to be a substantially same distance from the boundary are simultaneously provided to the first and second control units.

18. The method of claim 14, wherein the plurality of first and second image signals are provided by a row unit of gate lines.

19. A display device comprising:
a display panel including a plurality of first pixels disposed in a first display area and a plurality of second pixels disposed in a second display area;
a driving circuit unit configured to generate first and second image signals corresponding to the plurality of first and second pixels;
a first control unit configured to convert first image signals into first data voltages and to provide the first data voltages to the plurality of first pixels; and
a second control unit configured to convert second image signals into second data voltages and to provide the second data voltages to the plurality of second pixels,
wherein the plurality of first and second image signals corresponding to the first and second pixels disposed to be a substantially same distance from a boundary between the first display area and the second display area are simultaneously provided to the first and second control units.
